(19) United States
(12) Patent Application Publication
(10) Pub. No.: US 2014/0325479 A1
(43) Pub. Date: Oct. 30, 2014

(54) SYNCHRONIZATION OF AN AUTOMATION SCRIPT

(71) Applicant: HEWLETT-PACKARD DEVELOPMENT COMPANY, L.P., Houston, TX (US)

(72) Inventors: Michal Barak, Kiryat Ono (IL); Moshe Eran Kraus, Mazkeret Batya (IL); Einav Goldberg, Netanya (IL)

(73) Assignee: Hewlett-Packard Development Company, L.P., Houston, TX (US)

(21) Appl. No.: 13/869,359

(22) Filed: Apr. 24, 2013

(51) Int. Cl. G06F 11/36

(52) U.S. Cl. CPC G06F 11/3688
USPC 717/124

(57) ABSTRACT

Synchronization of an automation script can include determining an end event value for a step of an application based on an execution of the step, and synchronizing an automation script of the application using the determined end event value for the step.

### BACKGROUND

Business processes may be a factor in the operational success of an organization. The business processes may be implemented using applications, such as distributed applications (e.g., web applications). As such, the organization may have an interest in ensuring that the applications operate properly (e.g., as intended). The organization may, therefore, pursue testing an application to evaluate and/or fix problems associated with the application.

### BRIEF DESCRIPTION OF THE DRAWINGS

FIGS. 1A-1B illustrate example user interfaces according to the present disclosure.

FIG. 2 illustrates a block diagram of an example of a method for synchronizing an automation script according to the present disclosure.

FIG. 3 illustrates a flow chart of an example process for synchronizing an automation script according to the present disclosure.

FIG. 4 illustrates a block diagram of an example system according to the present disclosure.

### DETAILED DESCRIPTION

Testing applications, such as interface regression testing, can be laborious and time consuming to do manually. In addition, manual testing can be ineffective in finding classes of defects. Test automation can offer the possibility to perform such type of testing effectively. An automation test can include a written automation script of an application that can automate repetitive testing in a formalized testing process. That is, an automation script of an application can include script (e.g., machine-readable instructions) that executes and/or tests an application. For instance, the automation script can be written to, when executed, produce output according to the assertions that are part of the script. In various examples, user interfaces, such as a graphical user interface (GUI) can be tested to validate that the observable behavior of the application is correct.

Current technology has allowed distributed applications (e.g., web applications) to have increasing capabilities. A distributed application, as used herein, can include an application (e.g., machine-readable instructions) that is executed on multiple machines (e.g., a client and a server) in a network. For instance, distributed applications can use client side code, have dynamic content, and/or the content can reach the distributed application from the client in a number of different ways. For example, content can reach the distributed application using hypertext transfer protocol (HTTP), such as using push technology, and/or asynchronous JavaScript and extensible markup language (AJAX) calls. Example techniques for distributed applications to receive content can include polling (e.g., client asks the server periodically for updates), long polling (e.g., client asks the server for updates and the server only responds when it has an update), and push (e.g., client asks the server for update and the server responds with an endless response).

The advancement of Internet technology has presented difficulties in effectively creating automation tests of distributed applications. Some previous solutions have attempted to overcome such difficulties by creating machine-readable instructions (e.g., programs) that can create automation scripts of user action steps associated with a distributed application and that can interact with the distributed application to execute (e.g., play) the user action steps. A step, as used herein, can include execution of a particular function and/or task within a particular application. An application can include a plurality of steps that can be executed in a variety of orders. A user action step can include a step initiated by a user action (e.g., a user selects, clicks, types, etc., within a user interface). However, such previous approaches may not properly synchronize the automation test of user action steps. Synchronizing an automation test and/or automation script, as used herein, can include determining timing (e.g., how long and what should occur) between a user action step executed and execution of a next user action step.

For instance, different user action steps can result in a variety of timing and display differences. Consider a series of user action steps of a distributed application that include a user navigating to the Internet site, waits for something to happen, then selects (e.g., clicks) a link on the Internet site, then waits some more, enters some credentials, selects a menu item, selects a sub-menu item, etc. After some of the user action steps, the user may have to wait for the next user interface element to appear prior to acting on it. The amount of wait time may vary depending on internal application factors (e.g., server response time, client code efficiency, business logic) and/or external factors (e.g., server load, network bandwidth and latency, client hardware). The user, in various instances, may watch the distributed application and perform the next user action step simply because the user can see the user interface element is already there. For instance, the element may be there prior to the user interface completely loading.

Some previous approaches for synchronizing automation scripts of applications synchronize based on network traffic, a maximum wait time, and/or a wait step. Synchronizing based on network traffic can include waiting for the network traffic to finish prior to moving to the next user action step. However, the network traffic, in some instances (e.g., push technology) may never end and may lead to infinite step execution. A maximum wait time can include a threshold time to wait between steps. A wait step can include a set time to wait between each step. Setting a maximum wait time and/or adding a wait step, however, may result in distortion of reported transaction times, such as in load testing, due to waiting too long and/or not long enough (e.g., waiting longer or shorter than a user would in a real life situation). Transaction times, as used herein, can include a measurement of a part of a business process. The measurement can, for example, be expected to be similar to an experience of a real user (e.g., the transaction time measured can be expected to be similar to a transaction time a real user may experience). For instance, some user action steps may be performed without a wait time between them (e.g., setting fields in a form).

In contrast, examples of the present disclosure include methods, systems, and machine-readable and executable instructions for synchronizing automation scripts. The synchronization can, for instance, include executing (e.g., playing) a step (e.g., user action step) of an application to determine an end event value for the step. The end event value can be determined based on observation of processes (e.g., messages) that have been monitored during the execution of the step. An end event value, as used herein, can include a reference point to proceed to the next user action step in the automation script. Based on the determined end event value for the step, the automation script can be synchronized. For instance, the determined end event value for the step can be written into the automation script to synchronize the step. The synchronized automation script can be executed, for example, to test the application (e.g., an automation test).

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

In addition, the proportion and the relative scale of the elements provided in the figures are intended to illustrate the examples of the present disclosure, and should not be taken in a limiting sense. As used herein, the designators “N” and “P” particularly with respect to reference numerals in the drawings, indicates that a number of the particular feature so designated can be included with a number of examples of the present disclosure. Also, as used herein, “a number of” an element and/or feature can refer to one or more of such elements and/or features.

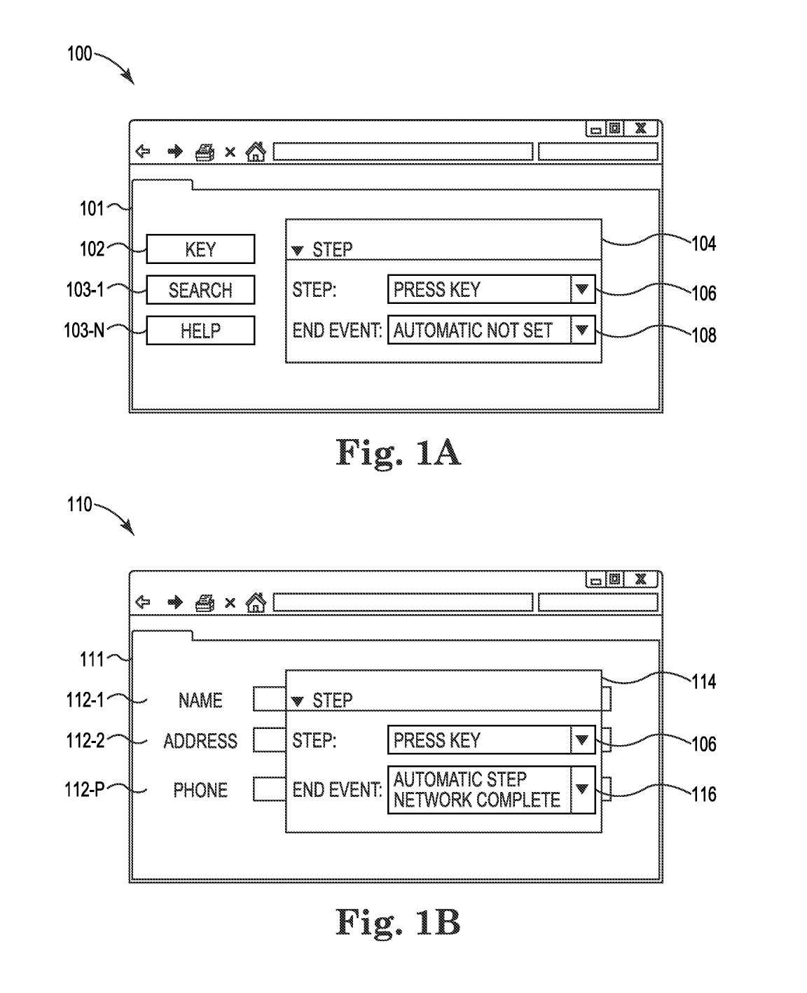

FIGS. 1A-1B illustrate example user interfaces 100, 110 according to the present disclosure. For instance, FIGS. 1A and 1B illustrate example user interfaces 100, 110 including a user interface of an application 101, 111 and a user interface of an automation tool 104, 114. An automation tool can include hardware components and/or machine-readable instruction components designated and/or designed to create and/or manage automation tests. For instance, the automation tool can be used to synchronize an automation script.

A user interface, as used herein, can be a space where interactions between a user and a machine occur (e.g., allows a user to interact with a machine using images and/or text). A user interface can include hardware components and/or machine-readable instruction components. For instance, hardware components can include input components (e.g., a mouse, a touch screen, and a keyboard) and output components for the computing device to indicate the effects of user input (e.g., display). An example user interface can include a graphical user interface (GUI). A GUI can, for example, represent actions and tasks (e.g., steps) available to a user through graphical icons and visual indicators.

The user interfaces 100,110 illustrated in FIGS. 1A and 1B can be associated with a machine and/or machine-readable instructions. For instance, the machine and/or machine-readable instructions can include a client. A client, as used herein, can include hardware components and/or machine-readable instruction components that initiate contact with a server to make use of a resource. A server can include hardware components and/or machine-readable instruction components that selectively share resources. The client and the server can exchange messages over a network to share resources. The messages can include requests and/or responses, wherein the client sends a request and the server returns a response. The messages can be sent using a communication link within the network and using a communication protocol. The network, in various examples, can include the Internet.

An application, as used herein, can include machine-readable instructions that cause a machine to perform a task. The application 101 can, in various examples, include a distributed application. For instance, a distributed application can include an application (e.g., machine-readable instructions) that is executed on multiple machines (e.g., a client and a server) in a network. In some instances, a distributed applicant can be accessed through the Internet. Distributed applications can perform business processes on a client and/or a server. A distributed application can, for instance, use Internet protocol to receive requests from a client, process the requests, and return data to the client (e.g., a response). Example distributed applications can include browsers (e.g., web browsers and/or domains).

The user interface 100 illustrated by FIG. 1A can include a user interface of an application 101 prior to executing a step 102, wherein the step 102 is to be executed by the automation tool to determine an end event value. The user interface of the application 101 can include a number of steps 102, 103-1, . . . , 103-N. The number of steps 102, 103-1, . . . , 103-N can include user action steps that a user can make using the application when the user interface of the application 101 is viewed by the user.

The user interface of the automation tool 104 can include an identification of a step 106 (e.g., user step action) and an end event 108. For instance, the user interface of the automation tool 104 can include a graphical icon showing the initial state of a user action step created (e.g., identified step 106). The identified step 106 can include an identification of step 102 illustrated in the application user interface 101 that is to be executed by the automation tool (e.g., played) to observe a process over the network and to define an end event value.

The end event 108 illustrated in the user interface of the automation tool 104 can include an undetermined value. For instance, an underdetermined value and/or an end event value prior to executing the step (e.g., as identified in step 106) can include “automatic not set”. An “automatic not set” end event value can include an indication that the identified step 106 has not been executed to determine an end event value using the automation tool.

The user interface 110 illustrated by FIG. 1B can include a user interface of the application 111 after executing the identified step 106 (e.g., the step 102 illustrated in FIG. 1A) and a user interface of the automation tool 114 after the step (e.g., step 102 illustrated in FIG. 1A) has been executed using the automation tool. For instance, the user interface of the application 111 can include a number of steps 112-1, 112-2, . . . , 112-P that occur after the step execution (e.g., step 102 illustrated in FIG. 1A). In such an instance, the step (e.g., step 102 illustrated in FIG. 1A) can include a current step and the number of steps 112-1, 112-2, . . . , 112-P can include a number of next steps. A next step, as used herein, can include a step executable after execution of a current step.

The user interface of the automation tool 114 illustrated by FIG. 1B can include identification of the step 106 (e.g., the step executed and illustrated by step 102 in FIG. 1A) and an end event value 116. For instance, the end event value 116 can be determined based on an execution of the step (e.g., as identified in 106). Example end event values can include action completed, document object model (DOM) loaded, DOM content loaded, timers ended, dialog opened, synchronous network completed, synchronous network almost completed, network completed, and/or network almost completed (e.g., as discussed further herein), among other values. The end event value 116 illustrated in FIG. 1B can include “network completed”. An end event value of “network completed” can include a reference for the automation script to wait for network traffic to complete. Such an end event value can be a default value, for instance.

By determining an end event value for a step (e.g., step 102 in FIG. 1A) based on an execution of the step, an automation tool can delay automation script execution in favor of activating the end event heuristics. Observing execution of the step can include monitoring processes that may change and/or create a DOM object that belongs to the next step during execution of the current step, and determine the end event value accordingly. Thereby, an end event value can include a reference point for the time that the next DOM object is ready for action. Because the determination of an end event value for a step is performed prior to automation script execution, the delay of execution may not be an issue since the user (e.g., a testing engineer) is not interested in transaction response time at that point. Further, the user can interact with the automation tool during automation script execution to assist in determining an end event value for a step that does not have observations (e.g., heuristics) with conclusive results.

Although the example user interfaces 100,110 illustrated in FIGS. 1A-1B illustrate a display of the application user interface 101, 111, examples in accordance with the present disclosure are not so limited. For example, user interlaces associated with the automation tool may not include a physical or graphical representation of the information associated the application (e.g., user interfaces of the application). Rather, the user interfaces of the application can be represented as data structure in a tangible medium (e.g., in memory of a computing system).

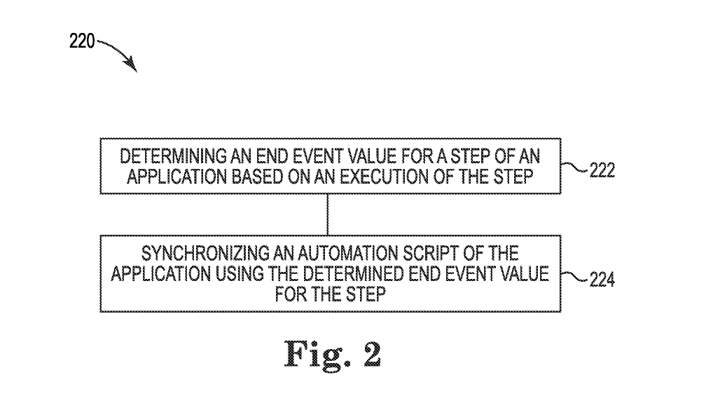

FIG. 2 illustrates a block diagram of an example of a method 220 for synchronizing an automation script according to the present disclosure. At 222, the method 220 can include determining an end event value for a step of an application based on an execution of the step. Determining an end event value, as used herein, can include setting an end event value for the step to be used in an automation script (e.g., written as a part of the automation script). An end event value can include a reference point to proceed to a next user action in the automation script.

An end event value can be determined based on a set of heuristics. The set of heuristics can be based on monitoring processes that affect a next step (e.g., as discussed further herein). A variety of end event values can be used based on the set of heuristics. An example of a variety of end event values can include the following:

| End Event Value | Meaning | Will be set for |
|---|---|---|
| Action Completed | Do the step and go to the | Steps that didn't |
| | next step immediately, | trigger network traffic |
| | do not wait. | or JavaScript timers |
| | | (e.g., setting a value |
| | | to a simple edit field). |
| DOM loaded | Waiting for the “onload” | Steps that the next |
| | event. | steps object was |
| | | ready at the time the |
| | | “onload” event |
| | | occurred. |
| DOM content loaded | Waiting for the | Steps that the next |
| | “DOMContentLoaded” | step(s) object was |
| | event | ready at the time the |
| | | “DOMContentLoaded” |
| | | event occurred. |
| Timers ended | Waiting for timers | Steps that triggered |
| | execution to end. | JavaScript timers but |
| | | no network traffic. |
| Dialog opened | Waiting for dialog to | Steps that triggered a |
| | open (e.g., alert, confirm, | dialog. |
| | prompt, authentication, | |
| | etc.) | |
| Synchronous | Waiting for network | Steps that the next |
| Network completed | traffic to start and to | step(s) object is ready |
| | complete excluding | at the time the |
| | traffic originating from | synchronous traffic |
| | “XMLHttpRequest” | has ended. |
| | objects. | |
| Synchronous | Waiting for network | Detected during the |
| Network Almost | traffic to start and to | execution of the step, |
| completed | complete except for a | including the |
| | designated number of | expected number of |
| | open HTTP requests and | open HTTP requests. |
| | excluding traffic | |
| | originating from | |
| | “XMLHttpRequest” | |
| | objects. | |
| Network completed | Waiting for network | Default. |
| | traffic to complete. | |
| Network almost | Waiting for network | Detected during the |
| completed | traffic to complete except | execution of the step, |
| | for a designated number | including the |
| | of open HTTP requests. | expected number of |
| | | open HTTP requests. |

At 224, the method 220 can include synchronizing an automation script of the application using the determined end event value for the step. Synchronizing an automation script, as used herein, can include defining the determined end event value for the step in the automation script (e.g., the determined end event value can be written into the automation script). The automation script can include, for instance, a script of user interface level automation test of the application. That is, the synchronized automation script can execute the application to perform a synchronized automation test. The automation script can be executed, for instance, to identify an amount of wait time (e.g., reference point) between a step and execution of a next step.

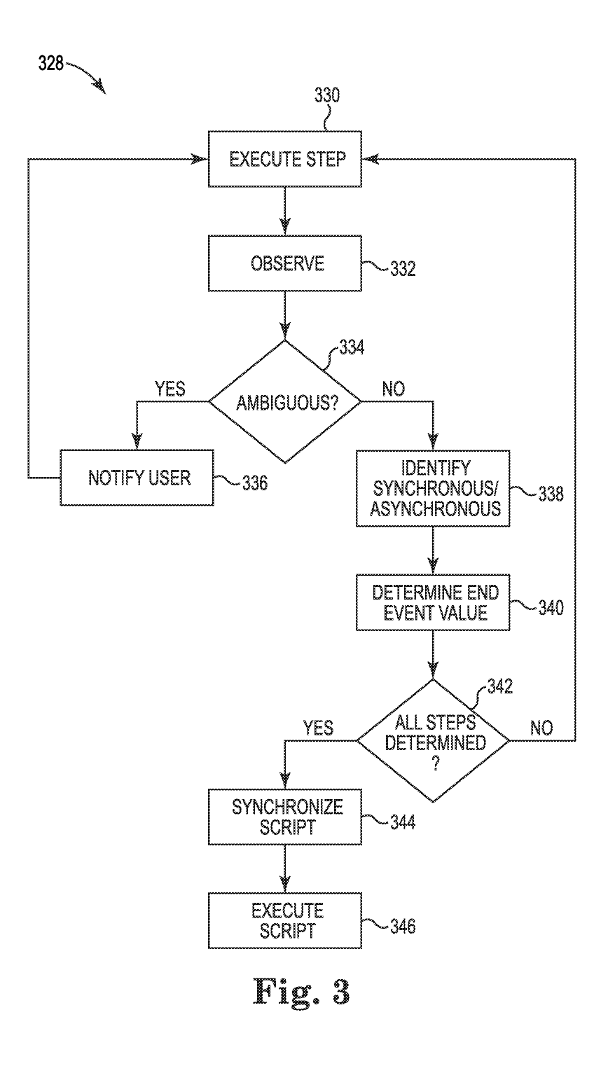

FIG. 3 illustrates a flow chart of an example process 328 for synchronizing an automation script according to the present disclosure.

At 330, the process 328 can include executing a step. The step can include a user action step of the application, for instance. A user action step of the application can include a user action associated with a user interface of the application. The application can, for example, include a distributed application. Execution of a step, as used herein, can include a run of the step.

At 332, the process 328 can include observation of the execution of the step. The observation, as used herein, can include monitoring a set of processes that affect the next step to define an end event value for the step (e.g., the current step). For instance, processes that affect the next step can include processes that change and/or create a DOM object which belongs to the next step (e.g., a user action step after the current user action step has been executed).

At 334, a determination can be made as to whether the observation (e.g., at 332) includes an ambiguous observation. An ambiguous observation can include an unclear and/or indefinite observation regarding an end event value of the step. For instance, if previous steps have waited too long, the end event value for the current step may be ambiguous.

In response to determining the observation includes an ambiguous observation, at 336, a user can be notified. The user can include, for instance, a testing engineer. The notification, in various examples, can include a message containing notification of the ambiguous observation and/or request for the user to assist in determining the end event value. For instance, a request can include a request for the user to reset the end event value to “automatic not set” and re-execute the step to re-determine the end event value of the step. The re-execution can occur, in some instances, once the user has corrected a number of previous steps. Once the user has reset the end event value, the process 328 can restart and/or repeat execution of the step (e.g., 330), observation of the execution (e.g., 332), and determination of an ambiguous observation (e.g., 334).

In response to determining the observation does not include an ambiguous observation, at 338, the process 328 can identify if the step includes a synchronous call and/or asynchronous call. For instance, a synchronous call can include a HTTP call that requests exchange of data over a network in order. That is, in a synchronous call, a client issues a request and waits for the corresponding response before doing anything else. An asynchronous call can include an HTTP call that requests exchange of data that may be out of order. That is, in an asynchronous call, a client issues a request but does not wait for the response, and continues with processing. In an asynchronous call, a handler function may be called to deal with the response when it arrives.

For instance, a call can be initiated by an extensible markup language (XML) HTTP Request (XMLHttpRequest) object. An XMLhttpRequest object can include an application programming interface (API) protocol used as an interface by machine-readable instruction components to communicate within distributed application scripting languages (e.g., JavaScript). An XMLhttpRequest object can send HTTP requests directly to a server and load the server response data directly back into the script. That is, the observation (e.g., at 332) can include monitoring network HTTP requests. Based on the observation of the call initiated by the XMLHttpRequest object, the process 328 can identify the steps (e.g., user action steps) that include a synchronous call and/or an asynchronous call.

At 340, the process 328 can include determining an end event value for the step (e.g., current user action step). For instance, the determination can be based on identification that the step includes a synchronous call and/or asynchronous call (e.g., at 338). For instance, if a synchronous call has ended, the end event value for the step can include “synchronous network completed”. If a synchronous call has not ended, the end event value for the step can include “synchronous network almost completed”. If an asynchronous call has ended, the end event value for the step can include “asynchronous network completed”. If an asynchronous call has not ended, the end event value for the step can include “asynchronous network almost completed”. End event values “synchronous network almost completed” and/or “asynchronous network almost completed” can include a reference point that limits the amount of network traffic that the automation script waits for before executing the next step. For instance, the limit can include an identified number of open HTTP requests.

At 342, a determination can be made as to whether all steps of the application (e.g., all steps associated with a user interface of the application) have an end event value determined. For instance, the application can include a plurality of steps. In response to identifying steps of the application do not have an end event value determined, the process 328 can repeat for the remaining steps (e.g., starting at 330).

In response to determining all of the steps (e.g., the plurality of steps) of the application have an end event value determined (e.g., the plurality of steps have been executed, the execution has been observed, and an end event value has been determined for each step), the automation script of the application can be synchronized using the determined end event values for each of the plurality of steps, at 344. For instance, synchronizing can include defining the determined end event values (e.g., reference points to move between a current step and a next step) in the automation script.

At 346, the synchronized automation script can be executed. For instance, executing an automation script can include a test of the application (e.g., an automation test). In some examples, the test of the application can include a determination of a time that the next DOM object is ready for action. Thereby, the test, in such an example, can include a reported transaction time and/or a load test. The synchronized automation script can, for instance, include a user action (e.g., step) script and the user action script can interact with the application (e.g., web browser) in order to replay the user actions (e.g., steps).

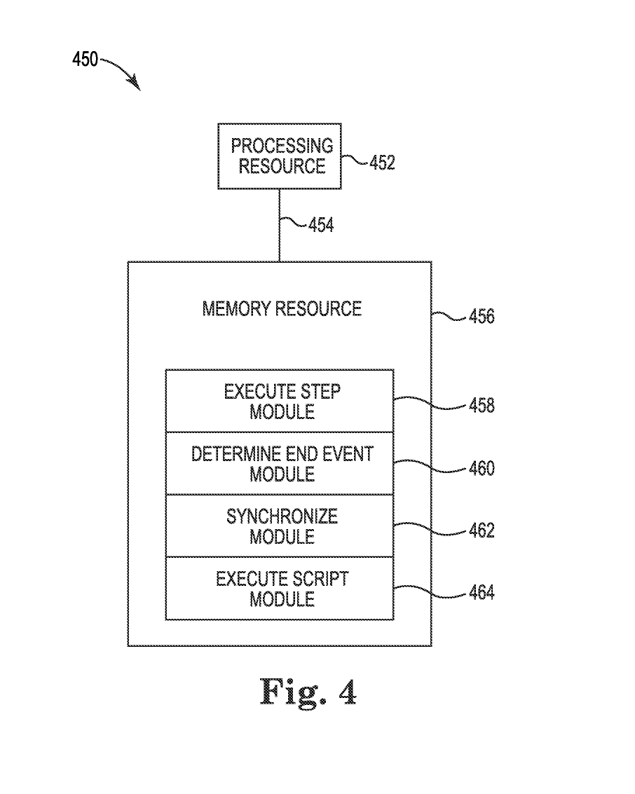

FIG. 4 illustrates a block diagram of an example of a system 450 according to the present disclosure. The system 450 can utilize software, hardware, firmware, and/or logic to perform a number of functions.

The system 450 can be any combination of hardware and program instructions configured to synchronize an automation script of an application (e.g., a distributed application). The hardware, for example can include a processing resource 452, a memory resource 456, and/or machine-readable medium (MRM) (e.g., computer-readable medium (CRM), database, etc.). A processing resource 452, as used herein, can include any number of processors capable of executing instructions stored by a memory resource 456. Processing resource 452 may be integrated in a single device or distributed across devices. The program instructions (e.g., machine-readable instructions (MRI)) can include instructions stored on the memory resource 456 and executable by the processing resource 452 to implement a desired function (e.g., observe execution of a plurality of user action steps of an application, etc.).

The memory resource 456 can be in communication with a processing resource 452. A memory resource 456, as used herein, can include any number of memory components capable of storing instructions that can be executed by processing resource 452. Such memory resource 456 can be a non-transitory MRM. Memory resource 456 may be integrated in a single device or distributed across devices. Further, memory resource 456 may be fully or partially integrated in the same device as processing resource 452 or it may be separate but accessible to that device and processing resource 452. Thus, it is noted that the system 450 may be implemented on a user and/or a client device, on a server device and/or a collection of server devices, and/or on a combination of the user device and the server device and/or devices.

The processing resource 452 can be in communication with a memory resource 456 storing a set of MRI executable by the processing resource 452, as described herein. The MRI can also be stored in remote memory managed by a server and represent an installation package that can be downloaded, installed, and executed. The system 450 can include memory resource 456, and the processing resource 452 can be coupled to the memory resource 456.

Processing resource 452 can execute MRI that can be stored on an internal or external memory resource 456. The processing resource 452 can execute MRI to perform various functions, include the functions described with respect to FIG. 1A, FIG. 1B, FIG. 2, and FIG. 3. For example, the processing resource 452 can execute MRI to observe execution of a plurality of user action steps of an application.

The MRI can include a number of modules 458, 460, 462, 464. The number of modules 458, 460, 462, 464 can include MRI that when executed by the processing resource 452 can perform a number of functions.

The number of modules 458, 460, 462, 464 can be sub-modules of other modules. For example, the determine end event module 460 and the synchronize module 462 can be sub-modules and/or contained within the same computing device. In another example, the number of modules 458, 460, 462, 464 can comprise individual modules at separate and distinct locations (e.g., machine-readable medium, etc.).

In some examples, the number of modules 458, 460, 462, 464 can include logic. As used herein, “logic” is an alternative and/or additional processing resource to execute the actions and/or functions, etc., described herein, which includes hardware (e.g., various forms of transistor logic, application specific integrated circuits (ASICs), etc.), as opposed to machine executable instructions (e.g., software, firmware, etc.) stored in memory and executable by a processing resource.

An execute step module 458 can include MRI that when executed by the processing resource 452 can perform a number of executing step functions. The execute step module 458 can observe execution of a plurality of user action steps associated with an application. For instance, the execute step module 458 can execute the plurality of user action steps to determine an end event value for each user action step among the plurality of user action steps.

A determine end event module 460 can include MRI that when executed by the processing resource 452 can perform a number of determining end event functions. The determine module 460 can determine an end event value for each user action step among the plurality of user action steps based on the observed execution of the plurality of user action steps.

A synchronize module 462 can include MRI that when executed by the processing resource 452 can perform a number of synchronization functions. The synchronize module 462 can synchronize an automation script of the application using the determined end event value for each of the plurality of user action steps. For instance, synchronizing the automation script can include defining the determined end event value for each user action step among the plurality of user action steps in the automation script (e.g., the end event values can be written into the automation script). The automation script can include, for instance, user actions.

In various examples, the system 450 can include an execute script module 464. An execute script module 464 can include MRI that when executed by the processing resource 452 can perform a number of executing script functions. The execute script module 464 can execute the synchronized automation script to test the application. For instance, the test can include an interaction between the synchronized automation script (e.g., that includes users action steps) and the application in order to re-execute the user step actions. The test can include, for example, a synchronized automation test of the application.

A memory resource 456, as used herein, can include volatile and/or non-volatile memory. Volatile memory can include memory that depends upon power to store information, such as various types of dynamic random access memory (DRAM), among others. Non-volatile memory can include memory that does not depend upon power to store information.

The memory resource 456 can be integral, or communicatively coupled, to a machine, in a wired and/or a wireless manner. For example, the memory resource 456 can be an internal memory, a portable memory, a portable disk, or a memory associated with another machine (e.g., enabling MRIs to be transferred and/or executed across a network such as the Internet).

The memory resource 456 can be in communication with the processing resource 452 via a communication path 454. The communication path 454 can be local or remote to a machine (e.g., a computing device) associated with the processing resource 452. Examples of a local communication path 454 can include an electronic bus internal to a machine (e.g., a computing device) where the memory resource 456 is one of volatile, non-volatile, fixed, and/or removable storage medium in communication with the processing resource 452 via the electronic bus.

The communication path 454 can be such that the memory resource 456 is remote from the processing resource (e.g., 452), such as in a network connection between the memory resource 456 and the processing resource (e.g., 452). That is, the communication path 454 can be a network connection. Examples of such a network connection can include a local area network (LAN), wide area network (WAN), personal area network (PAN), and the Internet, among others. In such examples, the memory resource 456 can be associated with a first machine and the processing resource 452 can be associated with a second machine (e.g., a Java® server). For example, a processing resource 452 can be in communication with a memory resource 456, wherein the memory resource 456 includes a set of instructions and wherein the processing resource 452 is designed to carry out the set of instructions.

The processing resource 452 coupled to the memory resource 456 can execute MRI to observe execution of a plurality of user action steps associated with an application. The processing resource 452 coupled to the memory resource 456 can also execute MRI to determine an end event value for each user action step among the plurality of user action steps based on the observed execution of the plurality of user action steps. The processing resource 452 coupled to the memory resource 456 can also execute MRI to synchronize an automation script of the application using the determined end event value for each of the plurality of user action steps.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for synchronization of an automation script, comprising:
determining an end event value for a step of an application based on an execution of the step; and
synchronizing an automation script of the application using the determined end event value for the step.

2. The method of claim 1, wherein synchronizing the automation script includes defining the end event value for the step in the automation script.

3. The method of claim 1, including executing the synchronized automation script of the application to perform an automation test of the application.

4. The method of claim 1, including executing the step to determine the end event value.

5. The method of claim 1, including monitoring a process that affects a next step to determine the end event value for the step.

6. The method of claim 1, including identifying an ambiguous observation regarding the end event and notifying a user of the ambiguous observation.

7. A non-transitory computer-readable medium storing a set of instructions executable by a processing resource to:
observe execution of a plurality of user action steps of an application;
determine an end event value for each user action step among the plurality of user action steps based on the observed execution of the plurality of user action steps; and
synchronize an automation script of the application using the determined end event value for each of the plurality of user action steps.

8. The medium of claim 7, wherein each end event value includes a reference point to proceed to a next user action step in the automation script.

9. The medium of claim 7, wherein the set of instructions are executable by the processing resource to execute the automation script to identify an amount of time for a next Document Object Model (DOM) object to be ready for action.

10. The medium of claim 7, wherein the instructions executable to determine each end event value include instructions executable to identify a current user action step includes at least one of a synchronous call and an asynchronous call based on an observed call initiated by the extensible markup language hypertext transfer protocol request (XMLHttpRequest) Object.

11. A system for synchronization of an automation script, the system comprising a processing resource in communication with a memory resource, the memory resource include a set of instructions and the processing resource is designed to carry of the set of instructions to:
execute a current user action step of an application;
determine an end event value for the current user action step based on the execution, wherein the end event value includes a reference point to proceed to a next user action step of the application;
synchronize the automation script using the determined end event value for the current user action step; and
execute the synchronized automation script to test the application.

12. The system of claim 11, wherein the set of instructions include instructions executable to:
identify the user action step includes a synchronous call; and
define the end event value for the user action step as synchronous network completed, in response to identification that the synchronous call has ended in the observed execution.

13. The system of claim 11, wherein the set of instructions include instructions executable to:
identify the user action step includes a synchronous call; and
define the end event value for the user action step as synchronous network almost complete, in response to identification that the synchronous call has not ended in the observed execution.

14. The system of claim 11, wherein the set of instructions include instructions executable to:
identify the user action step includes an asynchronous call; and
define the end event value for the user action step as asynchronous network completed, in response to identification that the asynchronous call has ended in the observed execution.

15. The system of claim 11, wherein the set of instructions include instructions executable to:
identify a user action step includes an asynchronous call; and
define the end event value for the user action step as asynchronous network almost complete, in response to identification that the asynchronous call has not ended in the observed execution.
